(19) United States
(12) Patent Application Publication
(10) Pub. No.: US 2018/0189810 A1
(43) Pub. Date: Jul. 5, 2018

(54) PROCESSING USER EXPERIENCE FEEDBACK IN A RETAIL ENVIRONMENT TO ASSIST CORRECTIVE ACTION

(71) Applicant: International Business Machines Corporation, Armonk, NY (US)

(72) Inventors: Jeremy A. Greenberger, Raleigh, NC (US); Jana H. Jenkins, Raleigh, NC (US)

(21) Appl. No.: 15/397,113

(22) Filed: Jan. 3, 2017

(51) Int. Cl. G06Q 30/02; G06Q 10/08

(52) U.S. Cl. CPC G06Q 30/0203; G06Q 10/087

(57) ABSTRACT

A method for processing user feedback of a retail venue is provided. The method includes requesting a feedback response from a mobile device upon the mobile device leaving the retail venue, receiving the feedback response indicating a user dissatisfaction because the user could not locate at least one retail item while present in the retail venue, identifying the retail item, determining a reason for the user dissatisfaction by ascertaining whether the retail venue stocks the at least one retail item, and: if not, then recommending to the retail venue to add the at least one item to an inventory of the retail venue, and if so, then analyzing, a physical path taken by the user within the retail venue using a micro-location data of the mobile device, and providing the reason for the customer dissatisfaction to the retail venue to assist the retail venue in taking a corrective action.

### TECHNICAL FIELD

The present invention relates to systems and methods of a feedback processing system, and more specifically to embodiments of a user feedback processing system and method that uses user feedback and micro-location data to diagnose a reason for user dissatisfaction for assisting corrective action.

### BACKGROUND

Retailers spend a significant amount of time and resources in planning a display of various retail items within a retail environment to make finding retail items convenient for customers. In the event a customer cannot locate a retail item in the retail environment, the retailer is only made aware of this dissatisfaction if the customer actively seeks out a representative of the retailer to complain, or ask where the retail item is located, and notes are taken. Additionally, the retailer does not fully understand why the customer could not locate the retail item.

### SUMMARY

An aspect of this invention relates to a method, and associated computer system and computer program product, for processing a user feedback of a retail venue. A processor of a computing system requests a feedback response from a mobile device upon the mobile device leaving the retail venue, the mobile device communicatively coupled to the computing system. The feedback response is received from the mobile device associated with a user in response to the requesting, the feedback response indicating a user dissatisfaction because the user could not locate at least one retail item while present in the retail venue. The at least one retail item that the user could not locate in the retail venue is identified. A reason for the user dissatisfaction is determined by ascertaining whether the retail venue stocks the at least one retail item, and if not, then adding the at least one item to an inventory of the retail venue is recommended, and if so, then a physical path taken by the user within the retail venue is analyzed using a micro-location data of the mobile device. The reason for the customer dissatisfaction is provided to the retail venue to assist the retail venue in taking a corrective action.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a block diagram of a feedback processing system, in accordance with embodiments of the present invention;

FIG. 2 depicts a block diagram of an embodiment of an intelligent location-based technology interface, which may be part of the feedback processing system depicted in FIG. 1, in accordance with embodiments of the present invention;

FIG. 3 depicts a flow chart of a method of processing user feedback of a retail venue, in accordance with embodiments of the present invention;

FIG. 4 depicts a mobile device displaying a feedback response request, in accordance with embodiments of the present invention;

FIG. 5 depicts a mobile device displaying a feedback response request to identify at least one retail item not located by the user within a retail venue, in accordance with embodiments of the present invention;

FIG. 6 depicts a flowchart of a step of the method of FIG. 3 for determining a reason for a user dissatisfaction with a retail venue, in accordance with embodiments of the present invention;

FIG. 7 illustrates a block diagram of a computer system for the feedback processing system of FIGS. 1-2, capable of implementing methods for processing user feedback of a retail venue of FIGS. 4-6, in accordance with embodiments of the present invention;

FIG. 8 depicts a cloud computing environment, in accordance with embodiments of the present invention; and

FIG. 9 depicts abstraction model layers, in accordance with embodiments of the present invention.

### DETAILED DESCRIPTION

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

Customers often times enter a retail environment with a particular list of retail items to purchase that the customers purchase frequently. In some cases, retailers change the location of one of those frequently purchased items, in which case the customer has difficulty finding the recently moved item, partly due to the habitual shopping pattern through the retail environment. The customer can become confused to the location of a frequently purchased item, resulting in the customer frustration. In other cases, the customer desires to purchase a product for the first time, and does not already know the location of the new product within the retail environment. If the customer cannot locate the new product, the customer may leave the retail venue upset, or dissatisfied. However, the retailer may not have knowledge of the customer dissatisfaction. The retailer may then continue to display a desired product in a poor location, or may make similarly bad decisions for other desired products.

Thus, a need exists for a feedback processing system and method that receives and analyzes user feedback to determine a reason for customer dissatisfaction to assist in corrective action that can be taken by the retailer to improve customer experience.

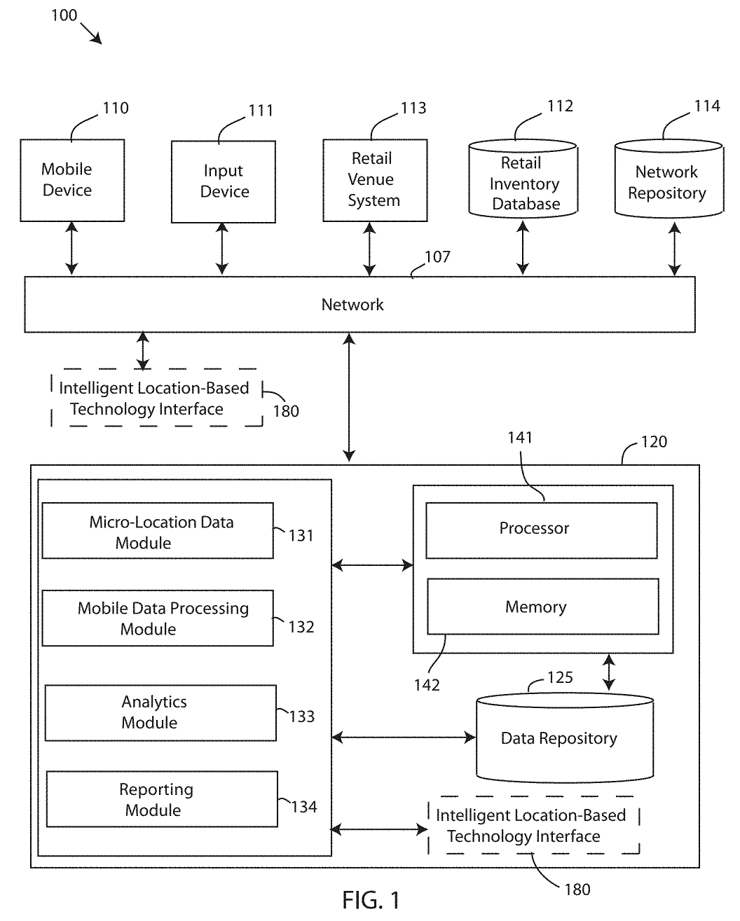

Referring to the drawings, FIG. 1 depicts a block diagram of a feedback processing system 100, in accordance with embodiments of the present invention. Embodiments a feedback processing system 100 may be described as a system for processing and analyzing user experience feedback to determine reasons for poor ratings or dissatisfaction with a retailer. The feedback processing system 100 may ask a user/customer how the user/customer's experience was when shopping at a retail venue. Embodiments of a retail venue may be a store, a retailer, a retail environment, a salesfloor, a grocery store, a supermarket, a home goods store, or any location that invites customers to purchase items from one or more displays. If the feedback received from the user/customer is negative, then the system 100 may diagnose or determine a reason why the user/customer had a negative experience at the retail venue. In particular, the feedback processing system 100 may determine a reason why the user/customer was not able to locate a retail item within the retail venue. In sore cases, the reason may be determined to be a result of the retailer not carrying or stocking the retail item, in which case the system 100 may recommend that the retailer add the retail item to an inventory of the retailer. In other cases, the reason may be determined to be that the customer missed the item while navigating the retail salesfloor. System 100 may analyze the physical path the user/customer took while shopping at the retailer to determine whether the retailer should consider taking a corrective action, such as relocate the retail item, add signage, increase display presence, etc. System 100 may feed the gathered information and analysis to retail management for potentially taking the corrective action to improve customer experience. Further, the feedback processing system 100 may aggregate a plurality of user's feedback to make recommendations based on a threshold value or number of users that could not locate the same item. The aggregate information may be helpful to the retailer when deciding to take corrective action with respect to one or more retail items and/or one or aspects of the salesfloor.

Embodiments of the feedback processing system 100 may comprise a mobile device 110 (and potentially an input device 111 in addition to the mobile device 110) communicatively coupled to a computing system 120 over a network 107. The number of input devices 111 connecting to computer system 120 over network 107 may vary from embodiment to embodiment, and may be dependent on the user of the mobile device 110. As shown in FIG. 1, the mobile device 110 and/or the input device 111 may transmit data, feedback, a feedback response, a micro-location data, answers to queries, identifying information, a location, environmental information, and the like, about the user or a movement of the user within the retailer (e.g. “feedback responses”) received or obtained from the mobile device 110 and/or input device 111 by connecting to computing system 120 over the network 107. A network 107 may refer to a group of two or more computer systems linked together. Network 107 may be any type of computer network known by individuals skilled in the art. Examples of computer networks 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the computer network 107 may be a peer-to-peer network in some embodiments, wherein in other embodiments, the network 107 may be organized as a client/server architecture.

In some embodiments, the network 107 may further comprise, in addition to the computer system 120, mobile device 110 and input device 111, a connection to one or more network accessible knowledge bases containing information of one or more users, network repositories 114 or other systems connected to the network 107 that may be considered nodes of the network 107. In some embodiments, where the computing system 120 or network repositories 114 allocate resources to be used by the other nodes of the network 107, the computer system 120 and network repository 114 may be referred to as servers.

The network repository 114 may be a data collection area on the network 107 which may back up and save all the data transmitted back and forth between the nodes of the network 107. For example, the network repository 114 may be a data center saving and cataloging user data sent by the mobile device 110 and/or input device 111 to generate both historical and predictive reports regarding a user's purchasing habits, shopping habits, preferences, movement or navigational habits of the user through one or more retail salesfloors. In some embodiments, a data collection center housing the network repository 114 may include an analytic module capable of analyzing each piece of data being stored by the network repository 114. Further, the computer system 120 may be integrated with or as a part of the data collection center housing the network repository 114. In some alternative embodiments, the network repository 114 may be a local repository (not shown) that is connected to the computer system 120.

Referring still to FIG. 1, embodiments of the computing system 120 may receive the feedback responses from the mobile device 110 and/or input device 111 which may be positioned within an environment shared by the user, worn by the user, and/or otherwise disposed in a location that can result in obtaining feedback responses. Input device 111 may be a sensor, an input device, or any input mechanism. For example, input device(s) 111 may be a biometric sensor, a wearable sensor, an environmental sensor, a camera, a camcorder, a microphone, a peripheral device, a computing device, a mobile computing device, such as a smartphone or tablet, facial recognition sensor positioned in one or more aisles of a retail venue, voice capture device, and the like. Embodiments of input device 111 may also include a heart rate monitor used to track a current or historical average heart rate of the user; wireless-enabled wearable technology, such as an activity tracker or smartwatch that tracks a heart rate; a blood pressure monitor; a perspiration sensor; and other wearable sensor hardware. Further embodiments of input device 111 not specifically listed herein may be utilized to collect feedback responses.

Further embodiments of input means 111 may include one or more input devices or input mechanisms, including one or more cameras positioned within an environment shared by the user. The one or more environment cameras may capture image data or video data of user, including a posture, facial expressions, perspiration, muscle activity, gestures, etc. Embodiments of the input device 111 may also include one or more microphones positioned nearby the user to collect audio relating to the user, and other hardware input devices, such as an audio conversion device, digital camera or camcorder, voice recognition devices, graphics tablet, a webcam, VR equipment, mouse, touchpad, stylus, and the like, which may help provide data relating to an experience or movement of the user within the retailer.

Furthermore, embodiments of the mobile device 110 may include a computing device, such as a smartphone or tablet device, associated with or operated by the user. Embodiments of the mobile device 110 may perform the same functions as described above with respect to the input device 111. The mobile device 110 may run various applications that contain data about the user. For example, a user's smartphone may be used as a sensor, and may also utilize the device's camera, microphone, and other embedded sensors to send information to the computing system 120. Moreover, the mobile device 100 may be communicatively coupled to the computing system 120, and may transmit information over a network 107. The mobile device 110 may include one or more hardware components for sending/receiving geolocation data of the mobile device 110.

Referring back to FIG. 1, embodiments of the computing system 120 may include a micro-location data module 131, a mobile data processing module 132, an analytics module 133, and a reporting module 134. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the computer system 120. A module (whether hardware, software, or a combination thereof) may be designed to implement or execute one or more particular functions or routines.

Embodiments of the micro-location data module 131 may include one or more components of hardware and/or software program code for obtaining, retrieving, collecting, or otherwise receiving a micro-location data of the user. In an exemplary embodiment, the micro-location data module 131 receives location data, micro-location data, and location-related metadata about the user, when the user is present in a retail venue, such as a salesfloor of a retailer (e.g. micro-location data). The micro-location data may be used to build a context that can be used for analysis and resulting actions. For example, the micro-location data may capture a physical path a user takes through the retail venue. Embodiments of the micro-location data module 131 may communicate with an intelligent location-based technology interface 180 to obtain or otherwise receive the micro-location data of the user. Embodiments of the interface 180 may be a component of the computing system 100, or may be external to the computing system 120, and connected to the computing system 120 over network 107.

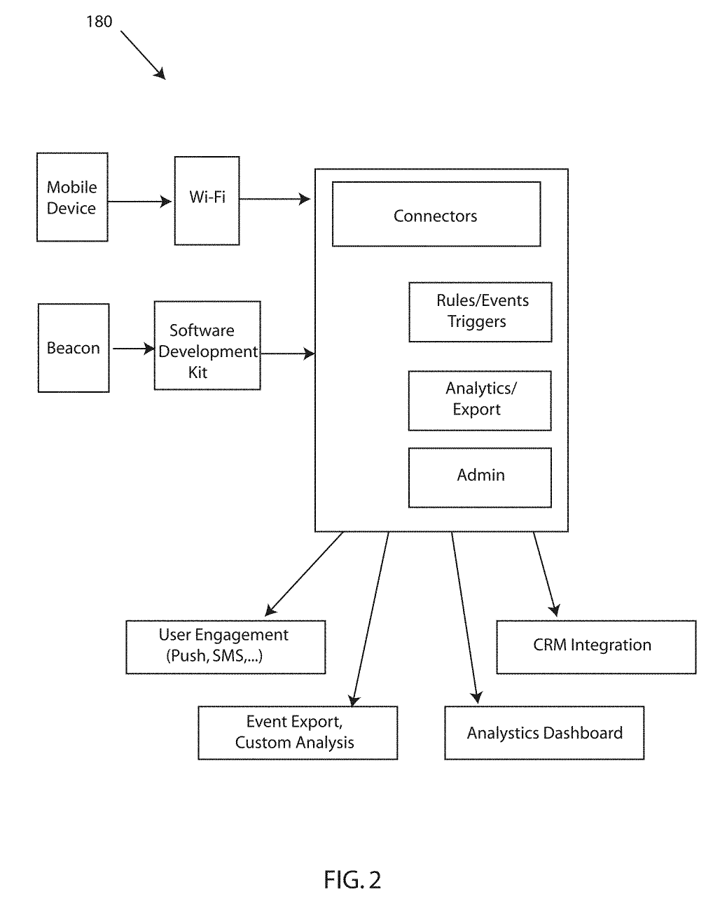

FIG. 2 depicts a block diagram of an embodiment of an intelligent location-based technology interface, which may be part of the feedback processing system 100 depicted in FIG. 1, in accordance with embodiments of the present invention. Interface 180 may enable venues associated with public spaces, healthcare, travel, stadiums, retail stores, and transportation businesses to extend customer service and support through mobile devices of the users utilizing the venue. For example, a retail venue can use interface 180 to transform an in-store customer experience by using intelligent location-based technology to engage patrons in near real-time to derive personal user data, including movements, traffic, etc. of the user while on the retailer salesfloor. Embodiments of the interface 180 may detect mobile device 110 that are communicating through radio signals using various protocols. In an exemplary embodiment, interface 180 may support Bluetooth Low Energy (BLE), Wi-Fi 802.11 on 2.4 GHz and 5 GHz radio communication protocols, for example. When a mobile device 110 is detected using one of the supported protocols, a Globally Unique Identifier (GUM) may be assigned for the mobile device 110. The GUID can be the MAC address for the device 110.

Accordingly, the mobile device 110 may be tracked as the mobile device 100 moves through the retail venue. All personally identifiable information (PII) including the MAC address or GUID may be encrypted by using a public key that is provided by the vendor to ensure that the customer data is secure. As the mobile device 110 moves through the retail venue, notifications can be triggered and sent enabling other back-office systems to take action, or may log a movement pattern throughout the retail venue. For instance, embodiments of interface 180 may include pre-configured reports that analyze mobile device 110 movement inside a venue. Specifically, a trajectory and movement behavior of the owner of the mobile device 110 may be captured or otherwise collected, and may be placed into a context of sites and zone regions of the retail venue. The reports generated by the interface 180, which may be received and/or processed by the micro-location data module 131, may enable sophisticated analysis of the retailer's customer data, such as movement patterns, site traffic, and owner preferences. As an example, interface 180 may obtain an average number of devices in a zone at any specified time, an average number of devices in the site at any specified time, how long the devices are staying in a particular zone at any specified time, how long the devices are staying in the site at any specified time, how many devices enter a particular zone on any specified date, and an overall number of devices that enter the site on any specified date, a number of devices, new versus repeating, that enter the site at any specified time. An exemplary embodiment of the intelligent location-based technology interface may be IBM® Presence Insights. Therefore, embodiments of the micro-location data module 131 may communicate with the interface 180 to obtain micro-location data, which may be used by the feedback processing system 100 to process and analyze feedback responses.

Referring back to FIG.1, embodiments of the computing system 120 may also include a mobile data processing module 132. Embodiments of the mobile data processing module 132 may include one or more components of hardware and/or software program code for receiving feedback responses from the mobile device 110, and/or the input device. For example, the mobile data processing module 132 may receive user data or feedback responses from the mobile device 110, when the mobile data processing module 132 (or other module) of the computing system 120 determines that the user/mobile device 110 is no longer on a retailer salesfloor, or outside a geographic proximity to the retailer. The feedback response(s) may be received from the mobile device 110 may be in response to a request from the mobile data receiving module 132. For instance, the mobile data processing module 132 may send a notification to the mobile device 110 when the mobile device 110 exceeds a proximity threshold from the retail venue, wherein the notification may be one or more queries. The one or more queries sent to the mobile device 110 may seek a feedback response from the user regarding a shopping experience at the retail venue. The mobile device 110 may prompt the user to respond to the one or more queries by displaying one or more questions on a display of the mobile device 110. The responses of the user may be transmitted from the mobile device 110 over the network 107 to the computing system 120, which may be received and/or processed by the mobile data processing module 132.

An exemplary query to the user may be whether the user was able to locate each retail item that the user was looking for at the retail venue. For example, the mobile data processing module 132 may send a request to the mobile device 110 of the user after the user leaves the retail venue to prompt the user to answer whether the user could not find one or more retail items. If the user indicates that the user was able to locate all of the retail items that the user was looking for while shopping at the retail venue, the mobile data processing module 132 may store the answer in data repository 125, and conclude that the user did not have a negative experience and/or was not dissatisfied. If the user indicates, by responding to the query prompted by the mobile device 110, that the user was unable to locate at least one retail item that the user was looking for at the retail venue, the mobile data processing module 132 may store the answer in data repository 125, and may conclude that the user is dissatisfied. In other words, the mobile data processing module 132 may determine that a feedback response from indicates a user dissatisfaction because the user could not locate at least one retail item while present in the retail venue. Embodiments of the user dissatisfaction may be a negative reaction or indication of a less than positive experience at the retail venue of the user because the user could not locate the at least one retail item while present in the retail venue.

If the mobile device processing module 132 has determined that a user dissatisfaction exists, then the module 132 may query the user to identify the one or more retail items that the user could not locate. For instance, the mobile data processing module 132 may identify the one or retail items listed by the user as unable to locate while shopping at the retail venue. The mobile data processing module 132 may send a request to the mobile device 110 in response to receiving confirmation that the user was unable to locate one or more retail items, which may prompt the user to identify the one or more retail items. In an exemplary embodiment, the mobile device 110 may allow the user to type in text describing the retail item. The mobile data processing module 132 may process the text, for example using natural language processing technologies, such as Alchemy language. In other embodiments, the user may dictate a description of the retail item, using voice-to-text technologies.

Referring still to FIG. 1, embodiments of the computing system 120 may further include an analytics module 133 for analyzing and determining a reason for the user dissatisfaction. Embodiments of the analytics module 133 may refer to configurations of hardware, software program code, or combinations of hardware and software programs, capable of analyzing data received from the mobile device device 110 and/or input device 111 and/or interface 180 to determine a reason for the user dissatisfaction, which may be utilized by the retailer to take a corrective action to correct, improve, address, etc. the user dissatisfaction. Embodiments of the analytics module 133 may ascertain whether the identified one or more retail items that could not be located by the user is stocked or carried by the retailer. For instance, the analytics module 133 may access or query a retail inventory database 112 associated with the retail venue to determine whether the identified retail item is indeed stocked or carried by the retailer. Embodiments of the retail inventory database 112 may be a database or other storage device maintained or otherwise controlled by the retailer, which includes a list of retail items that forms an inventory of the retailer. If the retail item is not stocked or carried by the retailer, or otherwise does not form part of an overall or current inventory of the retailer, then the analytics module 132 may transmit a recommendation to the retail venue system 113 to add or otherwise update the inventory of the retailer with the identified retail item. Embodiments of the retail venue system 113 may be a network, a computing system, a network of computers, a plurality of computers, databases, networks, and the like, associated with a particular retailer, which can be controlled and/or used by a management of the retailer to receive information/data transmitted by the computing system 120 for assisting corrective action taken by the retailer.

Furthermore, if the identified retail item is stocked or carried by the retail venue, then the analytics module 133 may utilize the data/information obtained, collected, retrieved, stored, etc. by the intelligent location-based technology interface 180 which has been communicated to the computing system 120, to analyze a characteristic of the user and/or movement of the user through the retail venue. In an exemplary embodiment, the analytics module 133 may analyze a physical path taken by the user inside the retail venue. The physical path of the user may refer to a movement of the user inside the retail venue, including an aisle-by-aisle movement of the user, while attempting; to locate each retail item in the retail venue. The physical path of the user may indicate whether a user traversed a particular aisle, or entered a particular area or department of the retailer, whether the user passed the desired retail item while present in the retail venue, or if the user travelled to or past a correct location of the retail item in the retail venue, or if the user travelled too quickly past the correct location of the retail item in the retail venue. Embodiments of the analytics module 133 may also examine a speed of the user as the user passed through an aisle of the retail venue, or past the correct location of the retail item. Various input devices 111 communicatively coupled to the computing system 120 or the interface 180 may obtain an eyesight direction to determine whether the user was looking at the user's mobile device (i.e. sending a text message, not paying attention to the retail items on the shelves). This may be helpful to determine whether the user was observant o re of the user's environment.

Embodiments of the analytics module 133 may compare the physical path of the user to the correct location of the retail item to determine if a corrective action could or should be taken by the retailer. Additionally, embodiments of the analytics module 133 may compare other information, such as an attention to an environment factor, with the corrective location, to determine if corrective action could or should be taken. For instance, if the user passed the correct location of the retail item, but was moving very quickly, then the retail item may be properly displayed. In another example, if the user passed the correct location of the retail item at a normal speed, but was looking down at the user's phone, the retail item may be properly displayed. However, if the user passed the correct location of the retail item, at a normal speed and adequate attention was paid by the user, then the analytics module 133 may determine that the retail item is not properly displayed, and needs more signage or direction (e.g. corrective action). Further, if the user did not pass the correct location of the retail item, then the analytics module 133 may determine that the retail venue should consider moving the retail item to a more proper or conspicuous location.

Furthermore, embodiments of the analytics module 133 may aggregate a plurality of user feedback to determine a reason for similar customer dissatisfaction. For instance, the analytics module 133 may obtain a threshold value of users that could not locate the same retail items within the retail venue, and utilize those aggregate statistics to determine suggested corrective actions that could be taken by the retailer.

With continued reference to FIG. 1, embodiments of the computing system 120 may include a reporting module 134. Embodiments of the reporting module 134 may include one or more components of hardware and/or software program code for reporting one or more reasons of user dissatisfaction to assist in determine one or more corrective actions. For instance, embodiments of the reporting module 134 may communicate with the retail venue system 113 to report or otherwise provide a reason for one or more user dissatisfactions so that the retail venue may use the feedback responses and diagnosed user dissatisfaction to consider a corrective action n other embodiments, the reporting module 134 may store diagnosed reasons for user dissatisfaction in data repository which may be accessed by the retail venue system 113. The retail venue may analyze the reasons/results sent by the reporting module 134 to assist in deciding whether to take a corrective action.

In some embodiments, the reporting module 134 may notify or otherwise report to the user a result of the analyzing by the analytics module 133. For example, the reporting module 134 may notify the user by sending a communication to the mobile device that the retail venue has been informed that the user was dissatisfied for one or more reasons. In further embodiments, the user may be notified that at least one retail item that the user was unable to locate was indeed not part of the retail venue's inventory, and that the computing system 120 has recommended to the retail venue to add the retail item.

Referring still to FIG. 1, embodiments of the computer system 120 may be equipped with a memory device 142 which may store the feedback responses and micro-location data, and a processor 141 for implementing the tasks associated with the feedback processing system 100.

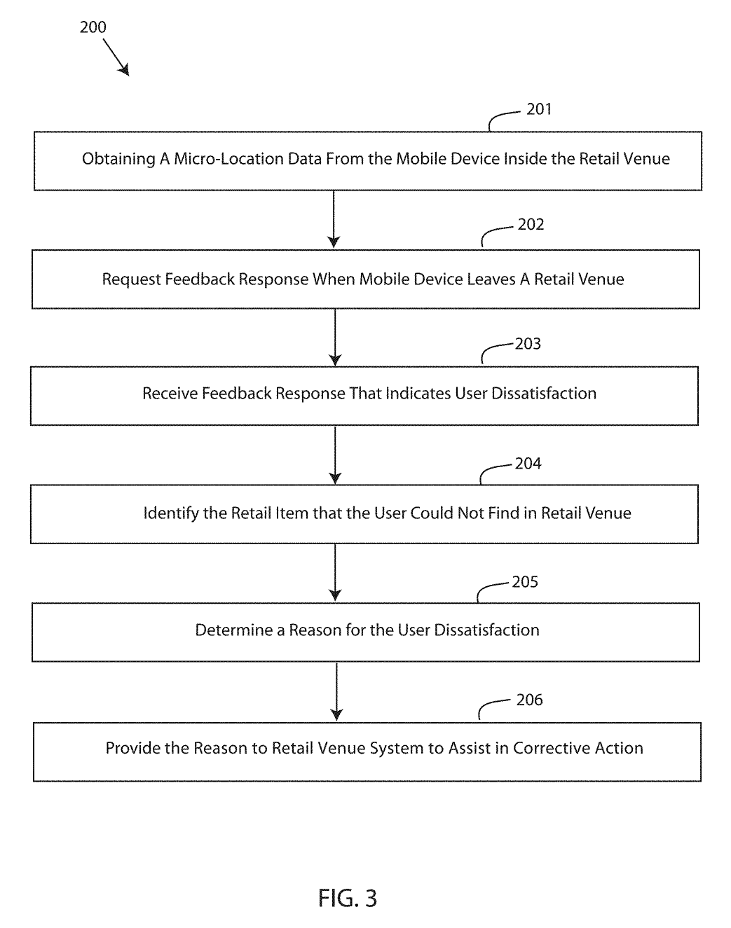

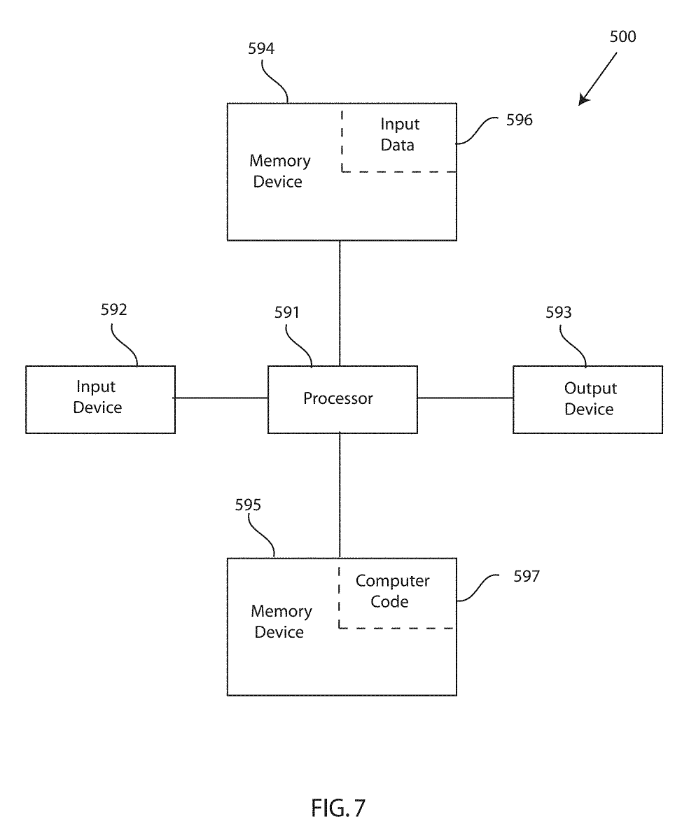

Referring now to FIG. 3, which depicts a flow chart of a method 200 for method of processing user feedback of a retail venue, in accordance with embodiments of the present invention. One embodiment of a method 200 or algorithm that may be implemented for processing user feedback of a retail venue in accordance with the feedback processing system 100 described in FIGS. 1-2 using one or more computer systems as defined generically in FIG. 7 below, and more specifically by the specific embodiments of FIGS. 1-2.

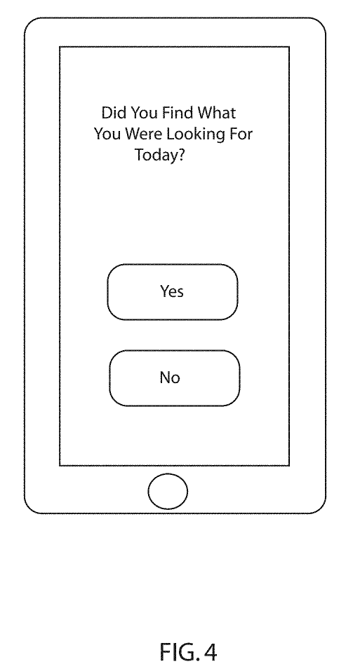

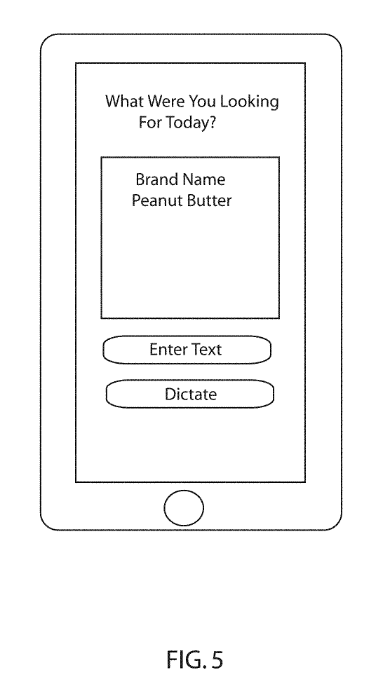

Embodiments of the method 200 for processing user feedback of a retail venue may begin at step 201 wherein micro-location data from the mobile device 110 is obtained, while the user is moving around within the retail venue. For instance, as the user traverses the salesfloor of the retail venue, the path taken by the user from aisle-to-aisle may be tracked, collected or otherwise captured. Other information may be gathered about the user while the user is present in the retail venue, such as data/information collected and transmitted by the input device 111 associated with the user or the user's mobile device 110, or associated with the retail venue, placed at various locations within the retail venue. When the user is finished shopping at the retail venue, step 202 requests a feedback response from the mobile device 110 when the mobile device 110 is detected to be outside the retail venue, or outside a threshold distance from the retail venue. In one embodiment, after the user has exited the retail venue (a time delay may be incorporated from a time the user leaves the retail venue), the mobile device 110 may receive a request from the computing system 120 to prompt the user to answer whether the use was able to locate all of the items desired to be purchased by the user. FIG. 4 depicts a mobile device displaying the feedback response request, in accordance with embodiments of the present invention. Step 203 receives the feedback response from the user, in response to the request for feedback. If the user indicates that the user was able to locate all of the items, then the computing system 120 may report to the retail venue 113 that the user was satisfied, or at least had no complaints. If the user indicates that the user was not able to locate all of the items, a user dissatisfaction may exist, and then step 204 identifies which items/goods the user was unable to locate at/in the retail venue. In an exemplary embodiment, the at least one retail item may be identified by asking the user to identify, using the user's mobile device 110, the product. FIG. 5 depicts a mobile device displaying a feedback response request to identify at least one retail item not located by the user within a retail venue, in accordance with embodiments of the present invention. Step 205 determines a reason for the user dissatisfaction.

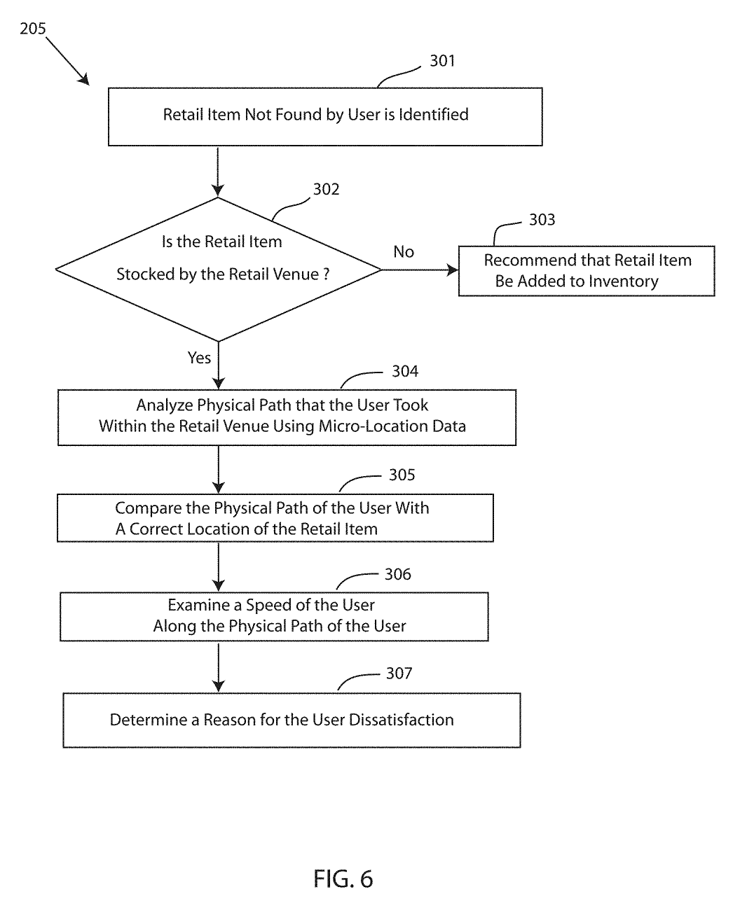

FIG. 6 depicts a flowchart of a step of the method of FIG. 3 for determining a reason for a user dissatisfaction with a retail venue, in accordance with embodiments of the present invention. Step 301 indicates confirms that at least one retail item not found by the user in the retail venue is identified by the computing system 120. Step 302 determines whether the at least one retail item stocked by the retail venue. If the at least one retail item is not stocked or carried by the retail venue, then step 303 recommends that the retail item be added or included to an inventory of the retail venue, so that the retail item will be available to the user in the future. If the retail item is not stocked by the retail venue, then step 304 analyzes a physical path that the user took within the retail venue using a micro-location to obtain the physical path of the user. Step 305 compares the physical path of the user within the retail venue to a correct location of the retail item not discovered or located by the user. Further, step 306 examines a speed of the user along the physical path of the user. Step 307 determines a reason for the user dissatisfaction based on steps 305, 306. For example, the physical path of the user may be compared to the correct location of the retail item to determine if the user came close to finding the item, or if the user walked by the item, or if the user was not even close to the correct location of the item. Given this information, a reason for the user dissatisfaction (e.g. user is frustrated because the user could not locate a desired item) may be determined, such as the user walked too fast, not enough signage was in place to alert the user to the correct location, the aisle markers are inaccurate or insufficient, other products are blocking or hiding the retail item, the user was not paying attention, the aisle was cluttered, and the like.

Referring back to FIG. 3, step 206 provides or otherwise sends the reason for the user dissatisfaction to the retail venue system 113 to assist in deciding whether to implement one or more corrective actions. The retail venue system 113 may be a computing system or network of computers accessible or operated by the retail venue management. Retail venues implementing method 300 of processing user feedback using the feedback processing system 100 may receive feedback from the retail venue's customers, which may be obtained after leaving the retail venue. Additionally,the user feedback may be analyzed so that the retail venue understands why a particular customer as dissatisfied, and whether or not the retail venue should make or implement a corrective action. Moreover, retail venues may analyze groups of user feedback responses that may have been aggregated by the computing system 120 and delivered to the retail venue system 113.

FIG. 7 illustrates a block diagram of a computer system for the feedback processing system of FIGS. 1-2, capable of implementing methods for processing user feedback of a retail venue of FIGS. 4-6, in accordance with embodiments of the present invention. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing method for processing user feedback of a retail venue, in the manner prescribed by the embodiments of FIGS. 4-6 using the feedback processing system of FIGS. 1-2, wherein the instructions of the computer code 597 may be executed by processor 591 via memory device 595. The computer code 597 may include software or program instructions that may implement one or more algorithms for implementing the methods for processing user feedback of a retail venue, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 7.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to feedback processing systems and methods. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to provide a user feedback processing system. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for processing user feedback of a retail venue. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for processing user feedback of a retail venue.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function's). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

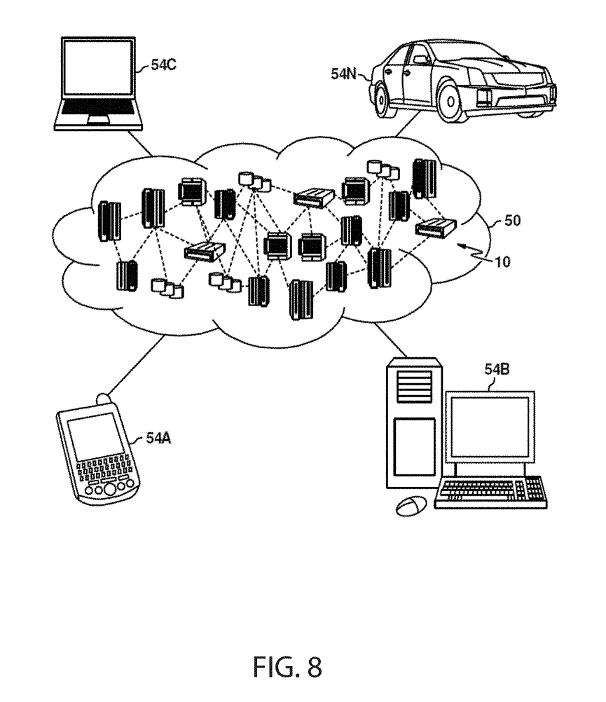

Referring now to FIG. 8, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 8 are intended to be illustrative only and that computing nodes 10 and cloud computing environment 50 can communicate with any type of computerized device over any type of network and/or network addressable connection (e.g., using a web browser)

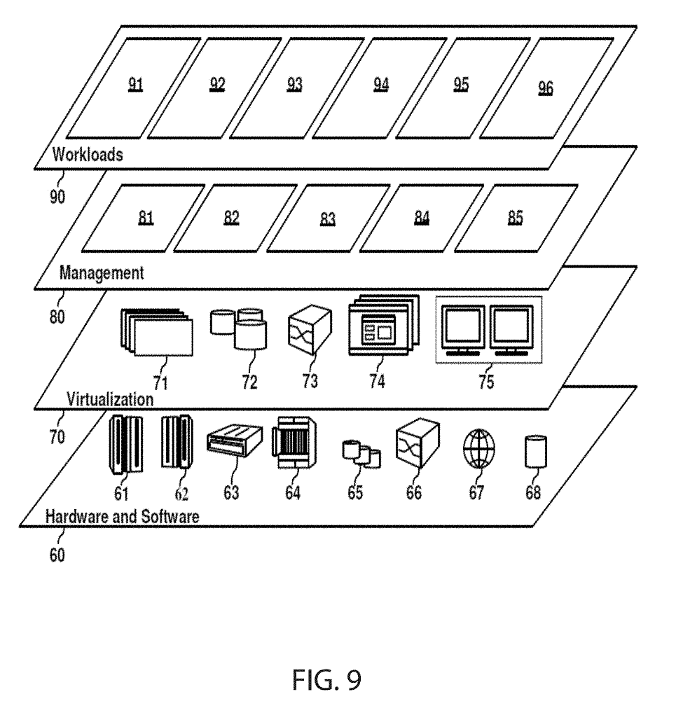

Referring now to FIG. 9, a set of functional abstraction layers provided by cloud computing environment 50 (see FIG. 8) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and user feedback of a retail venue processing 96.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein

1. A method of processing user feedback of a retail venue, the method comprising:
requesting, by a processor of a computing system, a feedback response from a mobile device upon the mobile device leaving the retail venue, the mobile device communicatively coupled to the computing system;
receiving, by the processor, the feedback response from the mobile device associated with a user in response to the requesting, the feedback response indicating a user dissatisfaction because the user could not locate at least one retail item while present in the retail venue;
identifying, by the processor, the at least one retail item that the user could not locate in the retail venue;
determining, by the processor, a reason for the user dissatisfaction by ascertaining whether the retail venue stocks the at least one retail item, and:
if not, then recommending, by the processor, to the retail venue to add the at least one item to an inventory of the retail venue, and
if so, then analyzing, a physical path taken by the user within the retail venue using a micro-location data of the mobile device; and
providing, by the processor, the reason for the customer dissatisfaction to the retail venue to assist the retail venue in taking a corrective action.

2. The method of claim 1, wherein the customer dissatisfaction is a negative reaction of the user because the user could not locate the at least one retail item while present in the retail venue.

3. The method of claim 1, wherein, if the retail venue stocks the at least one retail item, the analyzing includes determining if: the user travelled to a correct location of the at least one retail item in the retail venue, and the user travelled too quickly past the correct location of the at least one retail item in the retail venue.

4. The method of claim 1, further comprising: obtaining, by the processor, a micro-location data from the mobile device, while the user is present in the retail venue.

5. The method of claim 5, wherein the micro-location data is used to generate the physical path of the user within the retail venue.

6. The method of claim 1, wherein, if the retail venue stocks the at least one retail item, the identifying includes prompting, by the processor, the mobile device to request that the user input identifying information of the at least one retail item.

7. The method of claim 1, wherein, if the retail venue stocks the at least one retail item, taking a corrective action includes moving the at least one retail item to another physical location within the retail venue.

8. The method of claim 1, further comprising: aggregating, by the processor, a plurality of reasons for customer dissatisfaction to obtain a threshold value of users that could not locate the same retail items within the retail venue.

9. A computer system, comprising:
a processor;
a memory device coupled to the processor; and
a computer readable storage device coupled to the processor, wherein the storage device contains program code executable by the processor via the memory device to implement a method for processing user feedback of a retail venue, the method comprising:
requesting, by a processor of a computing system, a feedback response from a mobile device upon the mobile device leaving the retail venue, the mobile device communicatively coupled to the computing system;
receiving, by the processor, the feedback response from the mobile device associated with a user in response to the requesting, the feedback response indicating a user dissatisfaction because the user could not locate at least one retail item while present in the retail venue;
identifying, by the processor, the at least one retail item that the user could not locate in the retail venue;
determining, by the processor, a reason for the user dissatisfaction by ascertaining whether the retail venue stocks the at least one retail item, and:
if not, then recommending, by the processor, to the retail venue to add the at least one item to an inventory of the retail venue, and
if so, then analyzing, a physical path taken by the user within the retail venue using a micro-location data of the mobile device; and
providing, by the processor, the reason for the customer dissatisfaction to the retail venue to assist the retail venue in taking a corrective action.

10. The computer system of claim 9, wherein, if the retail venue stocks the at least one retail item, the analyzing includes determining if: the user travelled to a correct location of the at least one retail item in the retail venue, and the user travelled too quickly past the correct location of the at least one retail item in the retail venue.

11. The computer system of claim 9, further comprising: obtaining, by the processor, a micro-location data from the mobile device, while the user is present in the retail venue.

12. The computer system of claim 11, wherein the micro-location data is used to generate the physical path of the user within the retail venue.

13. The computer system of claim 9, wherein, if the retail venue stocks the at least one retail item, the identifying includes prompting, by the processor, the mobile device to request that the user input identifying information of the at least one retail item.

14. The computer system of claim 9, wherein, if the retail venue stocks the at least one retail item, taking a corrective action includes moving the at least one retail item to another physical location within the retail venue.

15. The computer system of claim 9, further comprising: aggregating, by the processor, a plurality of reasons for customer dissatisfaction to obtain a threshold value of users that could not locate the same retail items within the retail venue.

16. A computer program product, comprising a computer readable hardware storage device storing a computer readable program code, the computer readable program code comprising an algorithm that when executed by a computer processor of a computing system implements a method for processing a user feedback of a retail venue, comprising:
requesting, by a processor of a computing system, a feedback response from a mobile device upon the mobile device leaving the retail venue, the mobile device communicatively coupled to the computing system;
receiving, by the processor, the feedback response from the mobile device associated with a user in response to the requesting, the feedback response indicating a user dissatisfaction because the user could not locate at least one retail item while present in the retail venue;
identifying, by the processor, the at least one retail item that the user could not locate in the retail venue;
determining, by the processor, a reason for the user dissatisfaction by ascertaining whether the retail venue stocks the at least one retail item, and:
if not, then recommending, by the processor, to the retail venue to add the at least one item to an inventory of the retail venue, and
if so, then analyzing, a physical path taken by the user within the retail venue using a micro-location data of the mobile device; and
providing, by processor, the reason for the customer dissatisfaction to the retail venue to assist the retail venue in taking a corrective action.

17. The computer program product of claim 16, wherein, if the retail venue stocks the at least one retail item, the analyzing includes determining if: the user travelled to a correct location of the at least one retail item in the retail venue, and the user travelled too quickly past the correct location of the at least one retail item in the retail venue.

18. The computer program product of claim 16, further comprising: obtaining, by the processor, a micro-location data from the mobile device, while the user is present in the retail venue.

19. The computer program product of claim 16, wherein, if the retail venue stocks the at least one retail item, taking a corrective action includes moving the at least one retail item to another physical location within the retail venue.

20. The computer program product of claim 16, further comprising: aggregating, by the processor, a plurality of reasons for customer dissatisfaction to obtain a threshold value of users that could not locate the same retail items within the retail venue.
